(19) United States
(12) Patent Application Publication
(10) Pub. No.: US 2015/0331882 A1
(43) Pub. Date: Nov. 19, 2015

(54) REDUNDANT FILE DELETION METHOD, APPARATUS AND STORAGE MEDIUM

(71) Applicant: Tencent Technology (Shenzhen) Co., Ltd., Shenzhen (CN)

(72) Inventors: Liefen CHEN, Shenzhen (CN); Lei LONG, Shenzhen (CN)

(21) Appl. No.: 14/812,649

(22) Filed: Jul. 29, 2015

Related U.S. Application Data
(63) Continuation of application No. PCT/CN2013/086712, filed on Nov. 7, 2013.

(30) Foreign Application Priority Data
Jan. 30, 2013 (CN) 201310037452.2

(51) Int. Cl. G06F 17/30; G06F 9/445

(52) U.S. Cl. CPC G06F 17/30117; G06F 8/61

(57) ABSTRACT

A redundant file deletion method and apparatus and a storage medium are provided. Identifiers of all files in a program installation package are obtained. File association information in the program installation package is extracted, and the file association information is information associated with a file that has been used in the program installation package. According to the extracted file association information, an identifier of the file that has been used in the program installation package is obtained. An identifier of the redundant file is obtained according to the identifiers of all the files and the identifier of the file that has been used. The redundant file is deleted from the program installation package according to the obtained identifier of the redundant file.

### CROSS-REFERENCE TO RELATED APPLICATION

The application is a continuous application of International Application PCT/CN2013/086712, with title “REDUNDANT FILE DELETION METHOD, APPARATUS AND STORAGE MEDIUM”, and filed on Nov. 7, 2013, which claims priority to Chinese Patent Application No. 201310037452.2, with title “REDUNDANT PICTURE DELETION METHOD AND APPARATUS” filed on Jan. 30, 2013, with the Chinese Patent Office, both of which are incorporated herein by reference in their entirety.

### TECHNICAL FIELD

The present disclosure relates to security field, particularly to wireless security field, and in particular, to a redundant file deletion method and apparatus as well as a storage medium.

### BACKGROUND

With the continuous development of computer technology, the development period of Internet application programs is increasingly shorter, and the programs are updated more frequently. The update usually involves changes of picture resources. Some picture resources in an old version of a program may no longer be useful in a new version of the program. The inventor has realized that redundant pictures that are no longer useful may be deleted from the installation package of the program to reduce the size of the installation package.

All the pictures in the installation package may be extracted so that an application developer may select and delete redundant pictures manually. However, the inventor has found that such a method for deleting redundant pictures has at least the following problems.

The above redundant picture deletion method is only applicable to an application having a small amount of pictures because the selection of the redundant pictures is done by the application developer manually. For an application having a large amount of pictures, the manual selection needs much time and the accuracy for the selection is low. It is also the same for other types of files other than pictures.

### SUMMARY

Some embodiments of the present invention provide a redundant file deletion method. First, identifiers of all files in a program installation package are obtained. Then file association information in the program installation package is extracted, and the file association information is information associated with a file that has been used in the program installation package. According to the extracted file association information, an identifier of the file that has been used in the program installation package is obtained. An identifier of the redundant file is obtained according to the identifiers of all the files and the identifier of the file that has been used. The redundant file is deleted from the program installation package according to the obtained identifier of the redundant file.

Some embodiments of the present invention provides a redundant file deletion apparatus, including at least a processor coupled to a memory which stores executable instruction codes, wherein the instruction codes when executed by the processor, configures the apparatus to carry out a redundant file deletion method.

Some embodiments of the present invention further provides a non-transient computer readable storage medium including a computer executable instruction, which when being executed by a computer processor, cause the processor to carry out a redundant file deletion method.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a redundant file deletion method according to an embodiment of the present invention;

FIG. 2 is a flowchart of a redundant file deletion method according to another embodiment of the present invention;

FIG. 3 is a flowchart of a redundant file deletion method according to still another embodiment of the present invention;

FIG. 4 is a structure schematic diagram of a redundant file deletion apparatus according to an embodiment of the present invention; and

FIG. 5 is a structure schematic diagram of a redundant file deletion apparatus according to another embodiment of the present invention.

### DETAILED DESCRIPTION

In order to make the objectives, technical solutions, and advantages of the present disclosure clearer, the embodiments of the present invention are further described below in detail. Apparently, the described embodiments are a part rather than all of the embodiments of the present invention and aim at describing the principle of the present disclosure instead of limiting the present invention to the specific embodiments. All other embodiments obtained by a person skilled in the art based on the embodiments of the present invention without creative efforts shall fall within the protection scope of the present invention.

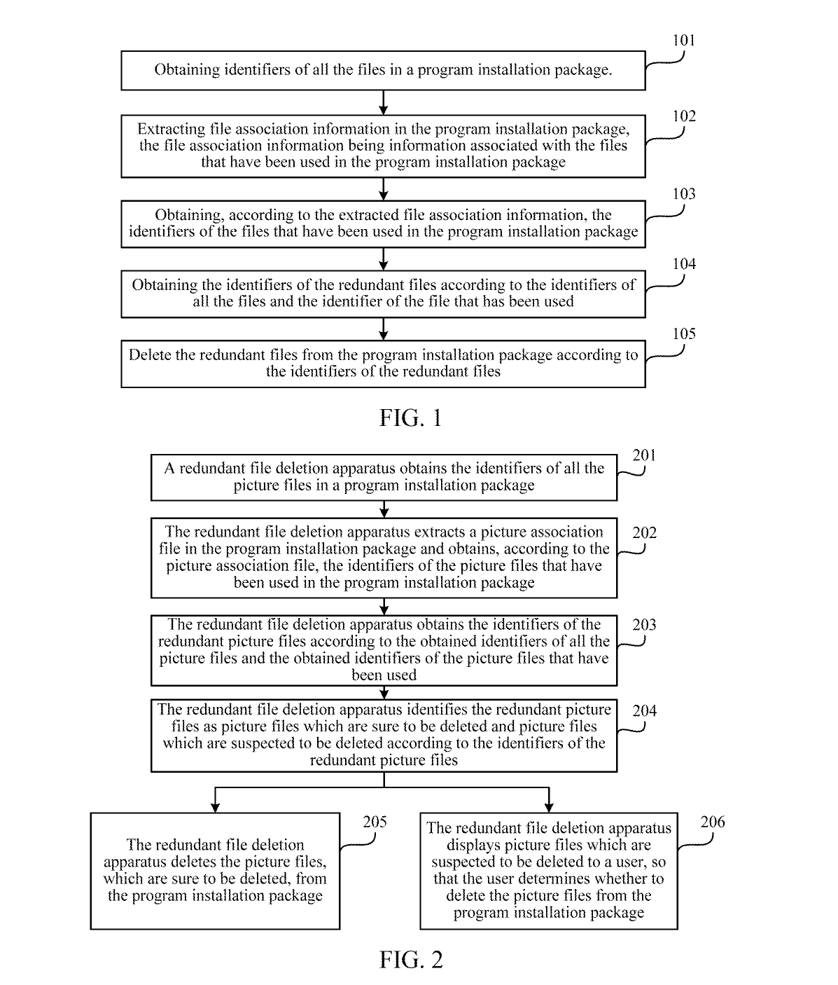

FIG. 1 shows a flowchart for deleting redundant files, for example, from a program installation package, according to an embodiment of the present invention. The type of the files to be deleted may include, for example, picture, audio, video, dynamic link library and so on. The program installation package may be all program-related files that are packed together before installation of the program and may also be a file package related to the program and generated locally after installation of the program. The redundant file deletion method provided in the embodiment of the present invention not only can be executed before the program is installed, but also can be used to process the redundant files after the program is installed.

The redundant file deletion method may be executed by a redundant file deletion apparatus. The redundant file deletion apparatus may be implemented by hardware, software or their combination and may be integrated in a device capable of processing the program installation package. The steps of the redundant file deletion method will be described detailed in the following.

At step 101, the identifiers of all the files in the program installation package are obtained.

At step 102, file association information (i.e., information associated with the files that have been used in the program installation package) in the program installation package are extracted.

The file association information may be any information associated with the files that have been used in the program installation package. An example of the file association information is a file association file in the program installation package. Examples of the file association file include, for example, an interface resource structure file, a program attribute file, and an executable file, which can indicate which files have been used. The file association information may also include for example information monitored in real time in installation and full operation processes, which can also indicate which files have been used.

At step 103, the identifiers of the files that have been used in the program installation package are obtained according to the extracted file association information.

At step 104, the identifiers of the redundant files are obtained according to the identifiers of all the files and the identifiers of the files that have been used.

At step 105, the redundant files are deleted from the program installation package according to the identifiers of the redundant files.

The disclosure does not intend to limit the order for performing the above steps. For example, the identifiers of all the files in the program installation package may be obtained at any time before step 104.

The redundant file deletion method according to the embodiment of the present invention may be applied to delete redundant files in a program installation package. The program installation package may be based on different operating systems, such as iOperating System (iOS, a handheld device operating system developed by Apple Inc.), Android (a “Android” operating system developed by Google Inc.), or Windows (an “Windows” operating system developed by Microsoft Corporation). Program installation packages developed based on different operating systems are generally of different types, and the embodiment of the present invention does not limit the type of the program installation package and the corresponding operating system.

According to the embodiment of the present invention, the identifiers of all the files and the identifiers of the files that have been used in the program installation package are obtained. The identifiers of the redundant files are obtained according to the identifiers of all the files and the identifiers of the files that have been used. And the redundant files are deleted from the program installation package according to the identifiers of the redundant files. Thereby, the problems of long-time manual selection of redundant files and low selection accuracy may be solved. Accordingly the time for the redundant file selection can be reduced and the accuracy for the redundant file selection can be improved. As a result, an application update period is reduced and development efficiency is improved.

According to the embodiment, the file may be, for example, a picture file, an audio file, a video file, and/or a dynamic link library file, and the like, and correspondingly, the file association information may be, for example, picture association information, audio association information, video association information, link library association information, or the like. The following embodiments are described by using pictures as an example. However, a person skilled in the art may understand that the following embodiments are also applicable to other types of files.

FIG. 2 is a flowchart for deleting redundant files according to another embodiment of the present invention. According to the embodiment, redundant picture files (which are only examples) are deleted from an application (app, a third-party application) installation package applicable to an iOS system. The redundant file deletion method of the embodiment will be described detailed in the following.

At step 201, a redundant file deletion apparatus obtains the identifiers of all the picture files in the program installation package.

The identifiers of the picture files may be the names of the picture files.

For example, for an iOS system-based app installation package the redundant file deletion apparatus may scan all the sub-directories of the app installation package to obtain the names of all the files having a picture type extension as the identifiers. For example, names of all the files whose extensions are picture types such as Joint Photographic Experts Group (JEPG, a picture file storage format) and Portable Network Graphic Format (PNG) are obtained and the obtained names of the picture files are stored to a resource array as the identifiers of all the picture files. With regard to deletion of redundant files of other types, the file identifier may also be obtained based on the extensions.

At step 202, the redundant file deletion apparatus extracts a picture association file in the program installation package and obtains, according to the picture association file, the identifiers of the picture files that have been used in the program installation package.

The picture association file is a file associated with the picture files that have been used in the program installation package.

The picture association file may include two types. One type is an interface resource structure file and/or a program attribute file. The interface resource structure file may indicate the picture files displayed on a user interface (UI) of the program installation package, and the program attribute file may indicate the picture files, such as icons, of the program. And the other type is an executable file. The executable file may be associated with a picture displayed in correspondence with each function of the program.

When the picture association file includes an interface resource structure file and/or a program attribute file, the redundant file deletion apparatus resolves the interface resource structure file and/or the program attribute file and obtains the identifiers of the picture files included in the interface resource structure file and/or the program attribute file as the identifiers of the picture files that have been used.

When the picture association file includes an executable file, the redundant file deletion apparatus resolves the executable file to obtain a symbol table corresponding to the executable file and obtains the identifiers of the picture files corresponding to the executable file from the symbol table as the identifiers of the picture files that have been used. The symbol table includes the execution symbols read from the executable file, which includes the identifiers of the picture files corresponding to the executable file.

For example, for an iOS system-based app installation package, the extension of the interface resource structure file is nil, and the extension of the program attribute file is plist. The redundant file deletion apparatus searches throughout all the sub-directories of the app installation package, adds files having extensions of nil and plist to a scan array “scanArray”, and adds all the executable files in the app installation package to the scan array “scanArray”.

The redundant file deletion apparatus searches throughout the scan array “scanArray”, adds the names of the picture files included in the files having the extensions of nil and plist to a symbol collection array “collectSymbolArray”, and meanwhile, adds the obtained symbol table of the executable files in the scan array “scanArray” to the symbol collection array “collectSymbolArray”. The redundant file deletion apparatus searches throughout the symbol collection array “collectSymbolArray” for the names of the picture files that are also stored in the resource array “sourceArray” and adds the names to an exit array “exitArray”. The names of the picture files in the exit array “exitArray” may be considered to be the names of the picture files that have been used.

At step 203, the redundant file deletion apparatus obtains the identifiers of the redundant picture files according to the obtained identifiers of all the picture files and the obtained identifiers of the picture files that have been used.

The redundant file deletion apparatus may compare the identifiers of all the picture files with the identifiers of the picture files that have been used and delete the identifiers of the picture files that have been used from the identifiers of all the files to obtain the identifiers of the redundant picture files. The picture files corresponding to the identifiers of the redundant picture files are redundant picture files.

For example, the redundant file deletion apparatus may delete the names of the picture files stored in the exit array “exitArray” from the resource array “sourceArray” to obtain a to-be-delete array “toBeDeleteArray”. The names of the picture files in the to-be-delete array “toBeDeleteArray” are the names of the redundant picture files.

At step 204, the redundant file deletion apparatus identifies the redundant picture files as picture files which are sure to be deleted and picture files which are suspected to be deleted according to the identifiers of the redundant picture files.

Since some picture files that have actually been used are not associated with the picture association file, for example, the picture files whose operation codes are added to their identifiers as a predetermined type of symbols. In this case, further selection needs to be performed according to the identifiers of the redundant picture files to improve selection accuracy.

The redundant file deletion apparatus may identify the identifiers that do not include this predetermined type of symbols, and determine that the redundant picture files corresponding to the identified identifiers are sure to be deleted. The redundant file deletion apparatus may also identify the identifiers that include this predetermined type of symbol, and determine that the redundant picture files corresponding to the identified identifiers are suspected to be deleted.

For example, for an iOS-based app installation package, operation codes of some picture files are added to the names of the picture files in a form of numerals, and the redundant file deletion apparatus may add the names of the picture files in the to-be-delete array “toBeDeleteArray”, that do not include any numeral, into a sure-to-delete array “sureToDeleteArray” and add the names of the picture files in the to-be-delete array “toBeDeleteArray”, that include numerals, into a suspect-to-delete array “suspectToDeleteArray”.

At step 205, the redundant file deletion apparatus deletes the picture files, which are sure to be deleted, from the program installation package.

In this step, the redundant file deletion apparatus may delete the picture files, which are sure to be deleted, according to their identifiers, from the program installation package.

For example, the redundant file deletion apparatus deletes the picture files corresponding to the names in the sure-to-delete array “sureToDeleteArray” from the app installation package.

At step 206, the redundant file deletion apparatus displays to a user the picture files which are suspected to be deleted, so that the user may determine whether to delete the picture files from the program installation package.

In this step, the redundant file deletion apparatus may display to the user the picture files according to their identifiers, so that the user may determine whether to delete these picture files from the program installation package.

For example, the redundant file deletion apparatus displays to a developer the picture files corresponding to the names in the suspect-to-delete array “suspectToDeleteArray”, so that the developer may determine whether to delete these picture files from the app installation package.

According to the embodiment of the present invention, the identifiers of all the picture files and the identifiers of the picture files that have been used in a program installation package are obtained, the identifiers of the redundant picture files are obtained according to the identifiers of all the picture files and the identifiers of the picture files that have been used, and finally the redundant picture files are deleted from the program installation package according to their identifiers. Thereby, the problems of long-time manual selection of redundant picture files and low selection accuracy may be solved. Accordingly the time for the redundant picture file selection can be reduced and the accuracy for the redundant picture selection can be improved. As a result, an application update period is reduced and development efficiency is improved. In addition, according to the embodiment of the present invention, after the identifiers of the redundant picture files are obtained, the redundant picture files are further identified as picture files sure to be deleted and picture files suspected to be deleted according to the identifiers of the redundant picture files. Then the picture files which are sure to be deleted are deleted from the program installation package, and the picture files which are suspected to be deleted are displayed to a user, so that the user determines whether to delete the picture files from the program installation package. Thus, the problem that some picture files that have actually been used cannot be selected by means of the picture association file can be solved, and thereby the redundant picture selection accuracy is further improved.

A person skilled in the art may understand that corresponding file association files also exist for files of other types, for example, an interface resource structure file, a program attribute file, an executable file and so on. These files may indicate which files have been used and file types may be identified on the basis of features such as an extension. Thus files that have been used may be determined. According to the embodiment, not only the same type of files which are redundant may be deleted, but several types of files which are redundant may also be deleted.

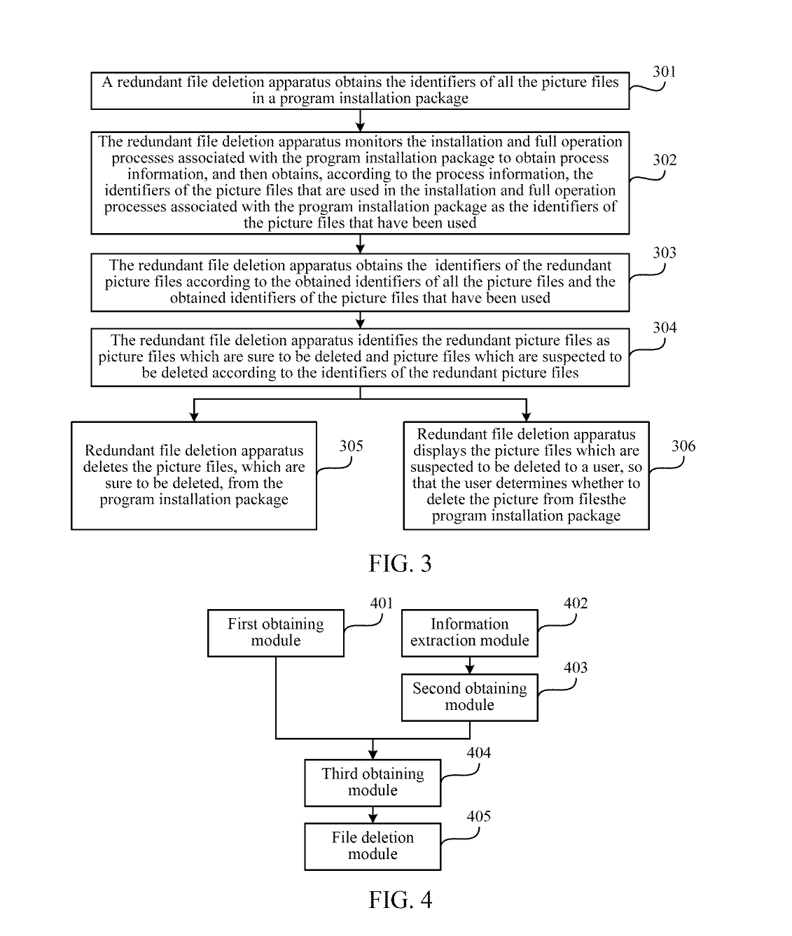

In the redundant file deletion method according to the forgoing embodiments, the selection of the files that have been used is static, that is, analyzing the program installation package to obtain the identifiers of the files that have been used. In addition, the present disclosure further provides a redundant file deletion method where files that have been used are dynamically selected with reference to FIG. 3. FIG. 3 shows a flowchart for deleting redundant files according to still another embodiment of the present invention. The embodiment is still described by using the picture file as an example. The redundant file deletion method will be described detailed in the following.

At step 301, a redundant file deletion apparatus obtains the identifiers of all the picture files in a program installation package.

The step 301 is similar to step 201 in the above embodiment, and will not be described detailed herein.

At step 302, the redundant file deletion apparatus monitors the installation and full operation processes associated with the program installation package to obtain process information and then obtains, according to the process information, the identifiers of the picture files that are used in the installation and full operation processes associated with the program installation package (i.e. the identifiers of the picture files that have been used).

Step 302 may be implemented by using Hook technology, which is well known in the art. In the Hook technology, hook is a section of message processing and is used for monitoring transmission of messages in a system and performing some specific processing on the messages before the final message processing process.

The developer generally installs a program by using the program installation package, and all functions in the installed program will be performed in sequence. That is, the developer will open all possible interfaces of the program to perform all possible operations, so as to complete a full operation process. The redundant file deletion apparatus monitors all functions that use picture resources in the system by using the Hook technology. When the functions are called, the redundant file deletion apparatus obtains the identifiers of the picture files corresponding to the called functions, and stores the obtained identifiers as the identifiers of the picture files that have been used.

At step 303, the redundant file deletion apparatus obtains the identifiers of the redundant picture files according to the obtained identifiers of all the picture files and the obtained identifiers of the picture files that have been used.

At step 304, the redundant file deletion apparatus identifies the redundant picture files as picture files which are sure to be deleted and picture files which are suspected to be deleted according to the identifiers of the redundant picture files.

At step 305, the redundant file deletion apparatus deletes the picture files, which are sure to be deleted, from the program installation package.

At step 306, the redundant file deletion apparatus displays to a user the picture files which are suspected to be deleted, so that the user may determine whether to delete the picture files from the program installation package.

The foregoing step 303 to step 306 are similar to step 203 to step 206 in the above embodiment, and will not be described detailed herein.

According to the embodiment of the present invention, the identifiers of all the picture files in a program installation package are obtained and the installation and full operation processes associated with the program installation package are monitored by using for example a Hook technology. The identifiers of the picture files that are used in the installation and full operation processes associated with the program is obtained as the identifiers of the picture files that have been used. The identifiers of the redundant picture files are obtained according to the identifiers of all the picture files and the identifiers of the picture files that have been used. And, the redundant picture files are deleted from the program installation package according to their identifiers. Thereby, the problems of long-time manual selection of redundant picture files and low selection accuracy may be solved. Accordingly the time for the redundant picture file selection can be reduced and the accuracy for the redundant picture selection can be improved. As a result, an application update period is reduced and development efficiency is improved.

In addition, according to the embodiment of the present invention, after the identifiers of the redundant picture files are obtained, the redundant picture files are further identified as picture files sure to be deleted and picture files suspected to be deleted according to the identifiers of the redundant picture files. Then the picture files which are sure to be deleted are deleted from the program installation package, and the picture files which are suspected to be deleted are displayed to a user, so that the user determines whether to delete the picture files from the program installation package. Thus, the problem that some picture files that have actually been used cannot be selected by means of the picture association file can be solved, and thereby the redundant picture selection accuracy is further improved.

Referring to FIG. 4, FIG. 4 is structure schematic diagram of a redundant file deletion apparatus according to an embodiment of the present invention. The redundant file deletion apparatus corresponds to the redundant file deletion method describe with reference to FIG. 1. The redundant file deletion apparatus may include a first obtaining module 401, an information extraction module 402, a second obtaining module 403, a third obtaining module 404 and a file deletion module 405, as shown in FIG. 4.

The first obtaining module 401 is configured to obtain the identifiers of all the files in a program installation package. The information extraction module 402 is configured to extract file association information (i.e., information associated with files that have been used in the program installation package) in the program installation package. The file association information is for example a file association file and may be any other information associated with the files that have been used. The information extraction module may also be referred to as a file extraction module. The second obtaining module 403 is configured to obtain, according to the file association information extracted by the information extraction module 402, the identifiers of the files that have been used in the program installation package. The third obtaining module 404 is configured to obtain the identifiers of the redundant files according to the identifiers of all the files obtained by the first obtaining module 401 and the identifiers of the files that have been used obtained by the second obtaining module 403. The file deletion module 405 is configured to delete the redundant files from the program installation package according to the identifiers of the redundant files obtained by the third obtaining module 404.

The redundant file deletion apparatus provided according to the embodiment of the present invention obtains the identifiers of all the files and the identifiers of the files that have been used in the program installation package, obtains the identifiers of the redundant files according to the identifiers of all the files and the identifiers of the files that have been used, and deletes the redundant files from the program installation package according to the identifiers of the redundant files. Thereby, the problems of long-time manual selection of redundant files and low selection accuracy may be solved. Accordingly the time for the redundant file selection can be reduced and the accuracy for the redundant file selection can be improved. As a result, an application update period is reduced and development efficiency is improved.

The redundant file deletion apparatus of the embodiment of the present invention is applicable to the deletion of redundant files of various types, for example, picture files, audio files, video files, dynamic link library files and so on. Accordingly, the file association information includes, for example, picture association information, audio association information, video association information, dynamic link library association information and so on.

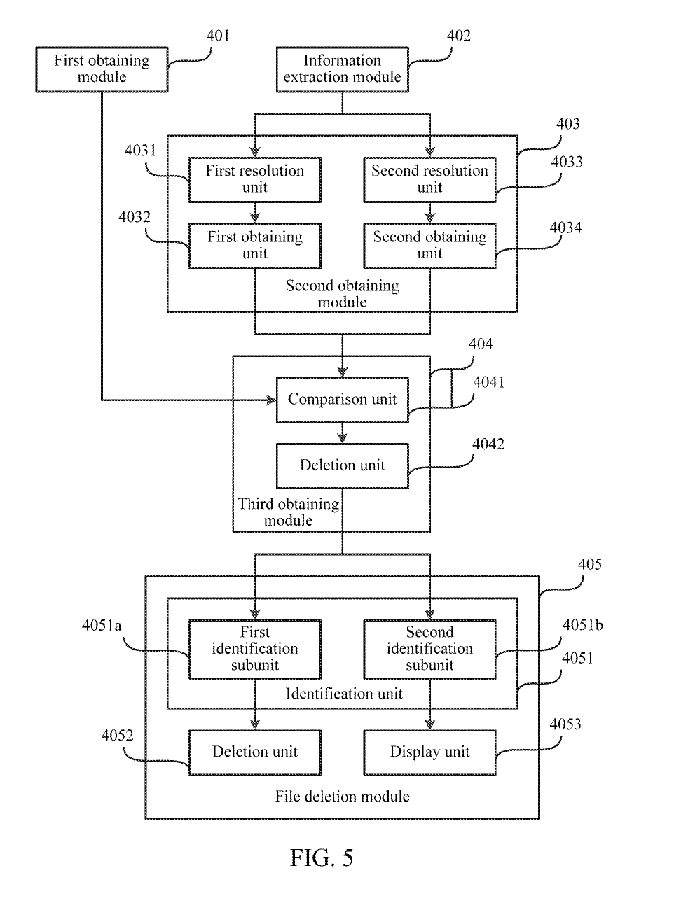

Referring to FIG. 5, FIG. 5 is structure schematic diagram of a redundant file deletion apparatus according to another embodiment of the present invention. The redundant file deletion apparatus may include a first obtaining module 401, an information extraction module 402, a second obtaining module 403, a third obtaining module 404 and a file deletion module 405.

The first obtaining module 401 is configured to obtain the identifiers of all the files in a program installation package. The information extraction module 402 is configured to extract file association information (i.e., information associated with files that have been used in the program installation package) in the program installation package. The second obtaining module 403 is configured to obtain, according to the file association information extracted by the information extraction module 402, the identifiers of the files that have been used in the program installation package. The third obtaining module 404 is configured to obtain the identifiers of the redundant files according to the identifiers of all the files obtained by the first obtaining module 401 and the identifiers of the files that have been used obtained by the second obtaining module 403. The file deletion module 405 is configured to delete the redundant files from the program installation package according to the identifiers of the redundant files obtained by the third obtaining module 404.

The file association information may be a file association file, including an interface resource structure file, a program attribute file and so on. In this case, the second obtaining module 403 includes a first resolution unit 4031 and a first obtaining unit 4032. The first resolution unit 4031 is configured to resolve the interface resource structure file and/or the program attribute file. The first obtaining unit 4032 is configured to obtain the identifiers of the files included in the interface resource structure file and/or the program attribute file as the identifiers of the files that have been used.

Alternatively, the file association information may be a file association file, including an executable file. In this case, the second obtaining module includes a second resolution unit 4033 and a second obtaining unit 4034. The second resolution unit 4033 is configured to resolve the executable file to obtain a symbol table corresponding to the executable file. The symbol table includes the identifiers of the files corresponding to the executable file. The second obtaining unit 4034 is configured to obtain the identifiers of the files corresponding to the executable file from the symbol table obtained by the second resolution unit 4033 as the identifiers of the files that have been used. The file association file includes an executable file.

Further alternatively, the information extraction module is configured to monitor the installation and full operation processes associated with the program installation package to obtain process information; and the second obtaining module is configured to obtain, according to the process information, the identifiers of the files that are used in the installation and full operation processes associated with the program installation package (i.e. the identifiers of the files that have been used).

According to embodiments of the invention, an interface resource structure file, a program attribute file, an executable file, and installation and full operation process information may, individually or in combination, are used to obtain the identifiers of the file that have been used, and the second obtaining module may include any or all of the foregoing units.

In addition, the third obtaining module 404 preferably includes a comparison unit 4041 and a deletion unit 4042. The comparison unit 4041 is configured to compare the identifiers of all the files with the identifiers of the files that have been used. The deletion unit 4042 is configured to delete the identifiers of the files that have been used from the identifiers of all the files to obtain the identifiers of the redundant files. The files corresponding to the identifiers of the redundant files are redundant files.

The file deletion module 405 includes for example a identification unit 4051, a deletion unit 4052 and a display unit 4053. The identification unit 4051 is configured to identify the redundant files as files which are sure to be deleted and files which are suspected to be deleted according to the identifiers of the redundant files obtained by the third obtaining module 404. The deletion unit 4052 is configured to delete the files, which are sure to be deleted, from the program installation package. The display unit 4053 is configured to display to a user the files which are suspected to be deleted, so that the user may determine whether to delete the files from the program installation package.

The identifiers of the files which are suspected to be deleted may include a predetermined type of symbols and the identification unit 4051 includes a first identification subunit 4051a and a second identification subunit 4051b. The first identification subunit 4051a is configured to identify the identifiers that do not include the predetermined type of symbols, and determine that the files corresponding to the identified identifier are sure to be deleted. The second identification subunit 4051b is configured to identify the identifiers that include the predetermined type of symbol, and determine that the files corresponding to the identified identifiers are suspected to be deleted. The deletion unit 4052 is configured to delete the files, according to their identifiers, from the program installation package. The display unit 4053 is configured to display to the user the files according to their identifiers.

The identifiers of files which are suspected to be deleted include the predetermined type of symbols and the predetermined type of symbols may be numerical symbols.

According to the embodiment of the present invention, the redundant file deletion apparatus obtains the identifiers of all the files and the identifiers of the files that have been used in a program installation package, obtains the identifiers of the redundant files according to the identifiers of all the files and the identifiers of the files that have been used, and finally deletes the redundant files from the program installation package according to the identifiers of the redundant files. Thereby, the problems of long-time manual selection of redundant files and low selection accuracy may be solved. Accordingly the time for the redundant file selection can be reduced and the accuracy for the redundant file selection can be improved. As a result, an application update period is reduced and development efficiency is improved. In addition, according to the embodiment of the present invention, the redundant file deletion apparatus provided in an embodiment of the present invention, after obtaining the identifiers of the redundant files, further identifies the redundant files as picture files sure to be deleted and picture files suspected to be deleted according to the identifiers of the redundant files, then deletes the files which are sure to be deleted from the program installation package, and displays the files which are suspected to be deleted to a user, so that the user determines whether to delete the files from the program installation package. Thus the problem that some files that have been used cannot be selected by means of the file association file can be solved, and thereby redundant file selection accuracy is further improved.

It should be noted that, division of the foregoing functional modules of the redundant file deletion apparatus is only an example. In actual application, the foregoing functions may be allocated to different functional modules as desired, that is, an internal structure of the apparatus is divided into different functional modules to implement all or some of the described above functions.

A person of ordinary skill in the art may understand that all or some of the steps of the foregoing embodiments may be implemented by using hardware, or may be implemented by a program instructing relevant hardware. The program may be stored in a computer readable storage medium. The above-mentioned storage medium may be a read-only memory, a magnetic disk, an optical disc, or the like.

The embodiments of the present invention further provide a storage medium including computer executable instructions, and the computer executable instructions cause a computer processor to perform a redundant file deletion method when being executed by the computer processor, and the method including:

obtaining identifiers of all the files in a program installation package;

extracting file association information in the program installation package, the file association information being information associated with the files that have been used in the program installation package;

obtaining, according to the extracted file association information, the identifiers of the files that have been used in the program installation package;

obtaining the identifiers of the redundant files according to the identifiers of all the files and the identifiers of the files that have been used; and

deleting the redundant files from the program installation package according to the obtained identifiers of the redundant files.

In the foregoing solution, the file includes for example a picture file, an audio file, a video file, and/or a dynamic link library file, and the like.

The step of extracting file association information in the program installation package for example includes monitoring the installation and full operation processes associated with the program installation package to obtain process information.

The step of obtaining, according to the extracted file association information, the identifiers of the files that have been used in the program installation package for example includes: obtaining, according to the process information, the identifiers of the file that are used in the installation and full operation processes associated with the program installation package as the identifiers of the files that have been used.

The file association information for example includes a file association file, including an interface resource structure file and/or a program attribute file. The step of obtaining, according to the extracted file association file, the identifiers of the files that have been used in the program installation package for example includes: resolving the interface resource structure file and/or the program attribute file and obtaining the identifiers of the files included in the interface resource structure file and/or the program attribute file as the identifiers of the files that have been used.

The file association information for example includes a file association file, including an executable file. The step of obtaining, according to the extracted file association file, the identifiers of the files that have been used in the program installation package includes:

resolving the executable file to obtain a symbol table corresponding to the executable file, where the symbol table includes the identifier of the files corresponding to the executable file; and

obtaining the identifiers of the files corresponding to the executable file from the symbol table as the identifiers of the files that have been used.

Based on the foregoing descriptions of the embodiments, a person skilled in the art may clearly understand that the present disclosure may be implemented by software in addition to general purpose hardware, or by hardware only. According to some embodiments, the technical solutions of the present disclosure may be embodied in a form of a software product. The computer software product may be stored in a computer readable storage medium, such as a floppy disk, a Read-Only Memory (ROM), a Random Access Memory (RAM), a FLASH, a hard disk, or an optical disc of the computer, and includes instructions used to instruct a computer device (which may be a personal computer, a server, a network device, or the like) to execute the methods according to the embodiments of the present invention.

The foregoing descriptions are merely exemplary embodiments of the present invention, but are not intended to limit the present disclosure. Any modification, equivalent replacement, or improvement made without departing from the spirit and principle of the present disclosure should all fall within the protection scope of the present disclosure.

What is claimed is:

1. A method for deleting a redundant file stored in a memory of a device, comprising a processor on the device performing the following on the memory of the device:
obtaining identifiers of all files in a program installation package;
extracting file association information in the program installation package, wherein the file association information is information associated with a file that has been used in the program installation package;
obtaining, according to the extracted file association information, an identifier of the file that has been used in the program installation package;
obtaining an identifier of the redundant file according to the identifiers of all the files and the identifier of the file that has been used; and
deleting the redundant file from the program installation package according to the obtained identifier of the redundant file.

2. The method according to claim 1, wherein the file that has been used in the program installation package comprises at least one of: a picture file, an audio file, a video file, and a dynamic link library file.

3. The method according to claim 1, wherein:
the extracting of the file association information in the program installation package, comprises:
monitoring an installation process and a full operation process associated with the program installation package to obtain process information; and
the obtaining, according to the extracted file association information, the identifier of the file that has been used in the program installation package, comprises:
obtaining, according to the process information, the identifier of at least a file that is used in the installation and full operation processes associated with the program installation package as the identifier of the file that has been used.

4. The method according to claim 1, wherein the file association information comprises a file association file, the file association file comprising at least one of an interface resource structure file and a program attribute file, and
the obtaining, according to the extracted file association file, the identifier of the file that has been used in the program installation package, comprises:
resolving the file association file; and
obtaining an identifier of at least a file comprised in the file association file as the identifier of the file that has been used.

5. The method according to claim 1, wherein the file association information comprises a file association file, the file association file comprising an executable file, and
the obtaining, according to the extracted file association file, the identifier of the file that has been used in the program installation package, comprises:
resolving the executable file to obtain a symbol table corresponding to the executable file, wherein the symbol table comprises an identifier of at least a file corresponding to the executable file; and
obtaining the identifier of the at least a file corresponding to the executable file as the identifier of the file that has been used.

6. The method according to claim 1, wherein the obtaining of the identifier of the redundant file according to the identifiers of all the files and the identifier of the file that has been used, comprises:
comparing the identifiers of all the files with the identifier of the file that has been used; and
deleting the identifier of the file that has been used from the identifiers of all the files to obtain the identifier of the redundant file,
wherein the redundant file corresponds to the identifier of the redundant file.

7. The method corresponding to claim 1, wherein the deleting of the redundant file from the program installation package according to the obtained identifier of the redundant file, comprises:
identifying the redundant file as a file which is sure to be deleted or a file which is suspected to be deleted according to the identifier of the redundant file;
deleting the file which is sure to be deleted, from the program installation package; and
displaying to a user, the file which is suspected to be deleted, so that the user determines whether or not to delete the file which is suspected to be deleted from the program installation package.

8. The method according to claim 7, wherein the identifier of the file which is suspected to be deleted comprises a predetermined type of symbol,
wherein the identifying of the redundant file as the file which is sure to be deleted or the file which is suspected to be deleted according to the identifier of the redundant file, comprising:
determining whether the identifier of the redundant file comprises the predetermined type of symbol,
determining that the redundant file is sure to be deleted, if the identifier of the redundant file does not comprise the predetermined type of symbol; and
determining that the redundant file is suspected to be deleted if the identifier of the redundant file comprises the predetermined type of symbol, and
wherein the deleting of the file which is sure to be deleted from the program installation package and displaying to a user the file which is suspected to be deleted, comprises:
deleting the file, which is sure to be deleted, from the program installation package, according to the identifier of the redundant file and displaying to the user the file which is suspected to be deleted, according to the identifier of the redundant file.

9. The method according to claim 8, wherein the predetermined type of symbol comprises a numerical symbol.

10. An apparatus for deleting a redundant file stored in a memory of a device, comprising:
at least a processor coupled to the memory which stores executable instruction codes, wherein the instruction codes when executed by the processor, configures the apparatus to:
obtain identifiers of all files in a program installation package;
extract file association information in the program installation package, wherein the file association information is information associated with a file that has been used in the program installation package;
obtain, according to the extracted file association information, an identifier of the file that has been used in the program installation package;
obtain an identifier of the redundant file according to the identifiers of all the files and the identifier of the file that has been used; and
delete the redundant file from the program installation package according to the obtained identifier of the redundant file.

11. The apparatus according to claim 10, wherein the file that has been used in the program installation package comprises at least one of a picture file, an audio file, a video file, and a dynamic link library file.

12. The apparatus according to claim 10, wherein the apparatus is further configured to:
monitor an installation process and a full operation process associated with the program installation package to obtain process information; and
obtain, according to the process information, the identifier of at least a file that is used in the installation and full operation processes associated with the program installation package as the identifier of the file that has been used.

13. The apparatus according to claim 10, wherein the file association information comprises a file association file, the file association file comprising at least one of an interface resource structure file and a program attribute file, and the apparatus is further configured to:
resolve the file association file; and
obtain an identifier of at least a file comprised in the file association file as the identifier of the file that has been used.

14. The apparatus according to claim 10, wherein the file association information comprises a file association file, the file association file comprising an executable file, and the apparatus is further configured to:
resolve the executable file to obtain a symbol table corresponding to the executable file, wherein the symbol table comprises an identifier of at least a file corresponding to the executable file; and
obtain the identifier of the at least a file corresponding to the executable file as the identifier of the file that has been used.

15. The apparatus according to claim 10, wherein the apparatus is further configured to:
compare the identifiers of all the files with the identifier of the file that has been used; and
delete the identifier of the file that has been used from the identifiers of all the files to obtain the identifier of the redundant file,
wherein the redundant file corresponds to the identifier of the redundant file.

16. The apparatus according to claim 10 wherein the apparatus is further configured to:
identify the redundant file as a file which is sure to be deleted or a file which is suspected to be deleted according to the identifier of the redundant file;
delete the file, which is sure to be deleted, from the program installation package; and
display to a user the file which is suspected to be deleted, so that the user determines whether or not to delete the file which is suspected to be deleted from the program installation package.

17. The apparatus according to claim 16, wherein the identifier of the file which is suspected to be deleted comprises a predetermined type of symbol, and the apparatus is further configured to:
determine whether the identifier of the redundant file comprises the predetermined type of symbol,
determine that the redundant file is sure to be deleted if the identifier of the redundant file does not comprise the predetermined type of symbol;
determine that the redundant file is suspected to be deleted if the identifier of the redundant file comprises the predetermined type of symbol;
delete the file which is sure to be deleted from the program installation package according to the identifier of the redundant file; and
display to the user the file which is suspected to be deleted according to the identifier of the redundant file.

18. A non-transient computer readable storage medium comprising computer executable instructions, which when being executed by a computer processor, cause the processor to:
obtain identifiers of all files in a program installation package;
extract file association information in the program installation package, wherein the file association information is information associated with a file that has been used in the program installation package;
obtain, according to the extracted file association information, an identifier of the file that has been used in the program installation package;
obtain an identifier of the redundant file according to the identifiers of all the files and the identifier of the file that has been used; and
delete the redundant file from the program installation package according to the obtained identifier of the redundant file.

19. The storage medium according to claim 18, wherein the file that has been used in the program installation package comprises at least one of a picture file, an audio file, a video file, and a dynamic link library file.

20. The storage medium according to claim 18, wherein:
the extracting of the file association information in the program installation package, comprises:
monitoring an installation process and a full operation process associated with the program installation package to obtain process information; and
the obtaining, according to the extracted file association information, the identifier of the file that has been used in the program installation package, comprises:
obtaining, according to the process information, the identifier of at least a file that is used in the installation and full operation processes associated with the program installation package as the identifier of the file that has been used.
